(19) United States
(12) Patent Application Publication
(10) Pub. No.: US 2011/0278907 A1
(43) Pub. Date: Nov. 17, 2011

(54) Concrete Profiler With Vacuum System

(75) Inventors: Karl H. Moller, North Palm Beach, FL (US); Roger J. Idema, Grand Rapids, MI (US)

(73) Assignee: DIAMOND PRODUCTS, LIMITED, Elyria, OH (US)

(21) Appl. No.: 13/074,437

(22) Filed: Mar. 29, 2011

Related U.S. Application Data
(60) Provisional application No. 61/333,812, filed on May 12, 2010.

(51) Int. Cl. E01C 23/06; E01C 23/09; B01D 45/00; E01C 23/088

(52) U.S. Cl. 299/18; 299/39.2; 55/385.1

(57) ABSTRACT

A concrete or asphalt profiling apparatus which operates without the use of a wetting agent includes a housing that encloses a plurality of diamond-tipped blades mounted to an arbor and adapted for high-speed rotation, and a suction device in communication with an area enclosed by the housing and configured to generate a suction force so to remove non-wetted dust generated during a profiling operation. During the profiling operation, a mixture of non-wetted dust and air can be drawn from the housing through a conduit and into a container by means of the suction device. An internally supported filter membrane extending into the container separates the concrete dust from the air in the mixture such that a portion of the concrete dust falls into a lower chamber and a portion of the concrete dust cakes on the filter membrane. The apparatus further includes a compressed air port that is adapted to selectively expel compressed air toward the filter membrane to dislodge concrete dust caked thereon.

This application claims priority to provisional Application Ser. No. 61/333,812 filed May 12, 2010 entitled “Concrete Profiler With Vacuum System” which is incorporated herein in its entirety.

### BACKGROUND

The present disclosure generally relates to an apparatus for profiling a concrete or asphalt surface. More particularly, the present disclosure relates to an apparatus for profiling a concrete or asphalt surface that includes a vacuum system for collecting non-wetted dust generated during the profiling of the concrete or asphalt surface.

Cutting blades, such as diamond-tipped cutting blades, are used in a variety of applications to profile concrete and asphalt surfaces. A “profiled” concrete or asphalt surface is one in which material has been cut and/or ground away using a diamond-tipped cutting blade. The term “profiler” references the apparatus used to profile the concrete or asphalt surface and is intended to include both a groover and a pavement surfacer. Profiling is done for a variety of reasons including, but not limited to, removing irregularities so as to flatten the profiled surfaces, texturing surfaces to reduce or prevent skidding, and creating grooves in surfaces to facilitate the drainage of water and to eliminate puddling. Concrete and/or asphalt profilers are used to profile highways, airport runways, bridge decks, industrial plants, stock pens, barns, and other surfaces.

In the case of relatively large profilers, several diamond-tipped cutting blades are typically mounted on an arbor. The arbor is mounted to the undercarriage of the profiler and is supported by bearings. An engine or other power source mounted to the profiler produces power, which is transmitted to the arbor such that it rotates the diamond-tipped cutting blades mounted thereon. When the rotating diamond-tipped cutting blades contact the concrete or asphalt surface, a portion of the concrete or asphalt is cut and/or ground away, thereby profiling the surface.

The profiling of concrete or asphalt surfaces creates a substantial amount of debris, which is hereinafter referred to as dust or concrete dust. Conventionally, water is sprayed onto the diamond-tipped cutting blades to cool and lubricate them, and also to wet the dust so that it does not become airborne. The wetted dust forms a slurry which must be removed from the surface continually during the profiling operation. Conventionally, this is accomplished using a slurry suction system.

Slurries of this type contain very hard particles and thus tend to be very abrasive. This leads to severe wear problems for the suction system, requiring frequent replacement of components. Furthermore, the addition of water to wet the dust creates a larger volume of waste material that needs to be handled.

### SUMMARY

According to one aspect, a dust removal system for use with a concrete or asphalt profiling apparatus includes a housing and a suction assembly. The housing is configured to cooperate with the surface to be profiled so as to create an enclosure that contains at least one saw blade of a cutting assembly which is configured to profile a surface to be profiled through high-speed rotation of at least one saw blade, the housing having an outlet opening. The suction assembly is in fluid communication with the housing outlet opening and is configured to generate a suction within the housing.

According to another aspect, an apparatus for profiling a concrete or asphalt surface comprises a cutting assembly, a housing, and a suction assembly. The cutting assembly is adapted to profile the surface through high-speed rotation of at least one blade. The housing is configured to cooperate with the surface so as to create an enclosure that contains the at least one blade of the cutting assembly, and has an outlet opening. The suction assembly is in fluid communication with the housing outlet opening and is configured to generate a suction within the housing.

According to still another aspect, a method of profiling a concrete or asphalt surface comprises providing a profiling apparatus. The provided profiling apparatus comprises: a cutting assembly adapted to profile the surface and including a arbor, a power supply configured to generate high-speed rotation of the arbor, and a plurality of diamond-tipped blades mounted to the arbor; a housing configured to cooperate with the surface so as to create an enclosure that contains the cutting assembly, the housing having an outlet opening; and a suction assembly in fluid communication with the housing outlet opening and configured to generate a suction within the housing. The method further comprises operating the power supply of the profiling apparatus to supply power that rotates the arbor and the plurality of diamond-tipped blades mounted thereon. The diamond-tipped blades mounted on the rotating arbor are contacted with the surface to be profiled such that a profile is formed in the surface and a mixture of non-wetted dust and air is formed. A mixture of the non-wetted dust and air is suctioned from the housing through the conduit and into the container.

### BRIEF DESCRIPTION OF THE DRAWINGS

FIG. 1 is a perspective view of an exemplary concrete or asphalt profiling apparatus according to the present disclosure.

FIG. 2 is a front view of the exemplary profiling apparatus according to the present disclosure.

FIG. 3 is an operational schematic illustration of the cutting assembly and suction elements of the exemplary profiling apparatus according to the present disclosure.

FIG. 4 is an operational schematic of a housing and cutting assembly of the exemplary profiling apparatus according to the present disclosure.

### DETAILED DESCRIPTION

The description and drawings herein are merely illustrative, and various modifications and changes can be made in the structures disclosed without departing from what is defined in the appended claims. All references to direction and position, unless otherwise indicated, refer to the orientation of the structures and components illustrated in the drawings and should not be construed as limiting the claims appended hereto. Like numbers refer to like parts throughout the several views.

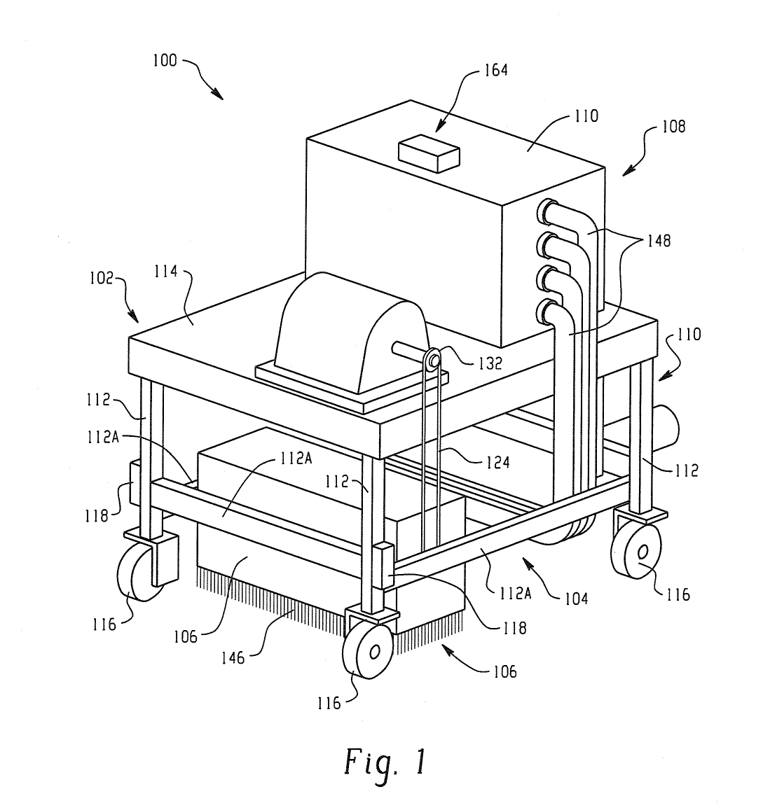

With reference to FIGS. 1-4, a concrete or asphalt surface profiling apparatus 100 (hereinafter, “profiling apparatus 100”) comprises a base frame 102 supporting a cutting assembly 104, a housing 106 covering at least a portion of the cutting assembly 104, and a suction assembly 108 communicating an interior of the housing 106 with a container 110. As described in further detail below, the profiling apparatus 100 is configured to profile a concrete or asphalt ground surface (e.g., a surface to be profiled) by contacting a portion of the cutting assembly 104 with the surface, and to remove and contain a non-wetted debris or dust created by the profiling of the surface. More particularly, the profiling apparatus 100 is configured such that a cutting or profiling of the surface to be profiled by the cutting assembly 104 substantially takes place within the housing 106, which is in communication with the suction assembly 108 and the container 110. The suction assembly 108 is configured to generate a suction within the housing 106 such that the non-wetted dust generated within the housing 106 during the profiling operation is removed from the housing 106 and directed into the container 110 for containment. In this regard, the profiling apparatus 100 facilitates the profiling of a surface to be profiled without the use of wetting agents, which are conventionally used to prevent dust generated during profiling from becoming airborne and to cool cutting/profiling blades. The generated dust is collected in the container 110, where it can be removed periodically for reuse or disposal.

With more particular respect to the profiling apparatus 100, the base frame 102 thereof defines a box-like frame provided: to support operational components of the profiling apparatus 100 (e.g., the cutting assembly 104, the suction assembly 106, the housing 108, and the container 110); to facilitate movement of certain operational components of the profiling apparatus 100 relative to the base frame 102; and to facilitate movement of the profiling apparatus 100. While it is to be appreciated that the base frame 102 may be configured in any of several different ways so as to perform the above supporting and facilitating functions, an exemplary configuration of the base frame 102 is shown in FIG. 1. As illustrated therein, the base frame 102 includes four substantially vertically-oriented post members 112, each of which being attached at an upper end to a substantially horizontally-oriented table 114 and at a lower end to one of a plurality of wheels 116. Additionally, the base frame 102 may include at least one cross member 112A which extends between and connects adjacent post members 112, as well as a drive system 118 for driving at least a subset of the plurality of wheels 116.

As shown in FIG. 1, the table 114 defines a generally rectangular peripheral shape and is connected, at each corner on a lower surface thereof, to one of the post members 112. The post members 112 orthogonally extend from the table 114 toward the ground surface such that the wheels 116 provided on the lower ends of the post members 112 are in contact with the ground surface. As will be described in further detail below, the table 114 is used to support certain operational components of the profiling apparatus 100. It is to be appreciated that the operational components of the profiling apparatus 100 may be relatively heavy, and as such, the base frame 102 may be formed of a high strength metal or steel. Moreover, the attachment of the post members 112 to the table 114 may be achieved via welding, or through the use of mechanical fasteners or any other known means.

The wheels 116 provided on the lower ends of the post members 112 are configured to allow rolling movement of the profiling apparatus 100 along a ground surface. In addition to allowing rolling movement of the wheels 116, the wheels 116 may be attached to the lower ends of the post members 112 so as to allow a turning of the wheels 116, e.g., rotation about an axis perpendicular to that associated with the rolling of the wheels 116. As such, the wheels 116 allow the profiling apparatus 100 to move and be steered along the ground surface.

To further facilitate movement of the profiling apparatus 100, at least one of the wheels 116 operationally engages the drive system 118, which is configured to force rotation of the operationally engaged wheel 116. The forced rotation of the operationally engaged wheel 116 drives movement of the profiling apparatus 100. In addition to forcing rotation of the operationally engaged wheel(s) 116, the drive system 118 may also be configured to function as a power steering system capable of turning the operationally engaged wheel(s) 116 about the respective post member 112 so as to steer the movement of the profiling apparatus 100.

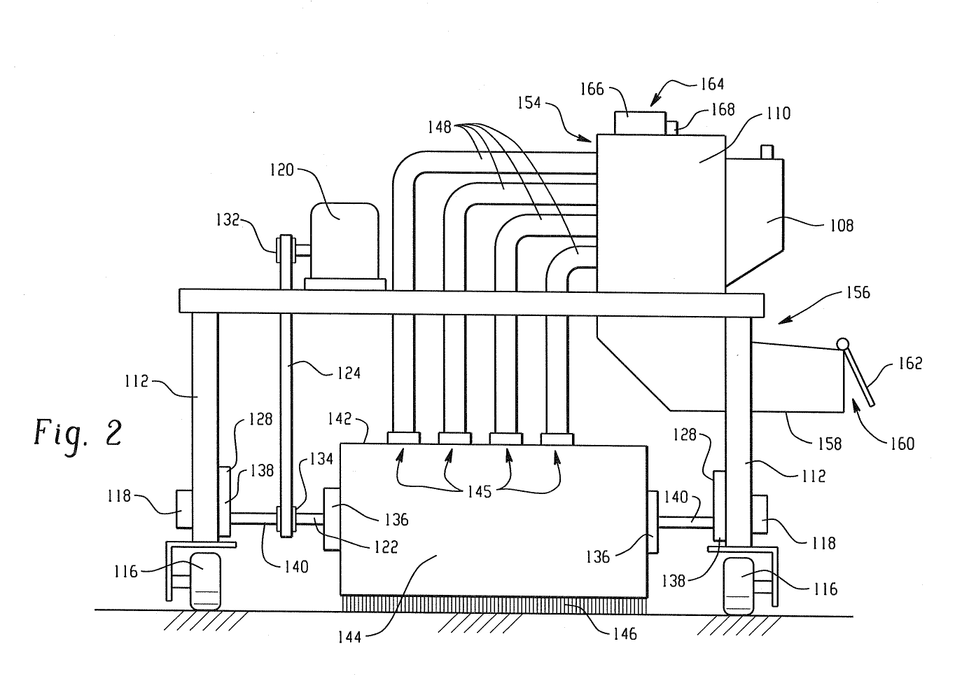

The drive system 118 may be a hydraulic drive system or any other type of drive system capable of driving rotation of one or more of the wheels 116 of the profiling apparatus 100. Wheel drive systems are believed to be generally well-known in the art, and as such will not be described in detail herein. As shown in FIG. 2, the exemplary profiling apparatus 100 includes two wheels 116 operationally engaged with the drive system 118. However, fewer or more wheels 116 may engage the drive system 118. Additionally, the wheels 116 may be provided with some manner of brake assembly (not shown) configured to forcibly halt rotation of the wheels 116 so as to hold the profiling apparatus 100 in a set position.

The profiling apparatus 100 may also include a user control section (not shown) configured to allow a user to control the drive system 118 and brake assembly, as well as the operational components of the profiling apparatus 100, so as to move, position, and control use of the profiling apparatus 100. It is noted that the drive system 118, brake assembly, and the engagement thereof with the wheels 116, is believed to be known in the art. As such, a detailed description of the structure and operation of the wheels 116, the drive system 118, and the brake assembly is not provided herein.

It is also to be appreciated that base frame 102 is exemplarily illustrated and described, and may be altered in various ways while remaining within the scope of the present disclosure. More particularly, it is to be appreciated that the base frame 102 may take any form or shape, using more or fewer post members 112, cross members 114, wheels 116, or other members, and may be made of any alternative material. Further still, while the base frame 102 incorporates a table 114, other structural members may be substituted to support the operational components of the profiling apparatus 100. Moreover, the drive system 118 and the brake assembly may be altered or reconfigured in any of several ways, or altogether removed, while remaining within the scope of the instant disclosure. In this regard, it is noted that any manner of base frame 102 capable of supporting the operational components of the profiling apparatus 100 may be used.

Turning to the operational components of the profiling apparatus 100, the cutting assembly 104, as shown in FIGS. 2-4, includes a power supply 120, a rotatable arbor 122 (hereinafter, “arbor 122”), a transmission member 124 connecting the power supply 120 to the arbor 122, a plurality of diamond-tipped blades 126 mounted on the arbor 122, and an articulation mechanism 128 configured to move the arbor 122 and plurality of diamond-tipped blades 126 relative to the base frame 102 (e.g., toward and away from the surface to be profiled, as well as in front-to-rear and side-to-side directions relative to the base frame 102). As will be explained in further detail below, the power supply 120 is configured to drive and rotate the arbor 122 such that the diamond-tipped blades 126 are integrally rotated to cut and/or profile the surface to be profiled. The transmission member 124 is used to translate rotation generated at the power supply 120 to the arbor 122, and the articulation mechanism 128 is used to at least raise and lower the arbor 122 and the diamond-tipped blades 126 relative to the surface to be profiled.

In the exemplary profiling apparatus 100, the power supply 120 may be a diesel engine. Diesel engines are considered to be generally well-known in the art, and as such, the power supply 120 will not be described in detail herein. It is noted that, as illustrated, the power supply 120 is secured to and supported by the base frame 102, e.g., the table 114 of the base frame 102. The power supply 120 includes a drive shaft 130, and is configured to cause the drive shaft 130 to rotate. While the power supply 120 may allow for varying drive shaft outputs or rotational speeds, a diesel engine may provide a drive shaft output of approximately 2100 rpm. It is noted that the power source 120 need not be a diesel engine, and may take the form of any other power source operational to force rotation of the arbor 122. Additionally, though illustrated as being supported by the table 114 of the base frame 102, the power source 120 may be alternatively disposed and/or supported.

The transmission member 124 is provided to allow the power source 120 to force rotation of the arbor 122. More particularly, the transmission member 124 is provided to transmit rotation from the power source drive shaft 130 to the arbor 122. The exemplary transmission member 124 shown in the appended figures is a belt member connecting the power source drive shaft 130 to the arbor 122 so as to allow the arbor 122 to be integrally rotated with the power source drive shaft 130. To facilitate engagement of the power source drive shaft 130 with the transmission member 124, the drive shaft 130 may be provided with a belt receiving wheel 132 at a distal end thereof, with the belt receiving wheel 132 defining a recessed channel in which the transmission member 124 rests and is secured. Similarly, the arbor 122 may also be provided with a belt receiving wheel 134 having a recessed channel in which the transmission member 124 rests and is secured.

It is to be appreciated that the transmission member 124 need not take the form of a belt member. In this regard, any manner of transmission member capable of allowing the power source 120 to force rotation of the arbor 122 may be used. More particularly, any manner of transmission member capable of translating a rotational force generated by the power source 120 and power source drive shaft 130 to the arbor 122 is amenable with the herein described profiling apparatus 100. For example, the transmission member 124 can take the form of an elongated member extending between the power source drive shaft 130 and the arbor 122, and including one or more belts and/or gears used to transmit rotation from the power source drive shaft 130 to the arbor 122. As a further alternative, the drive shaft 130 may be directly integrated and/or engaged with the arbor 122.

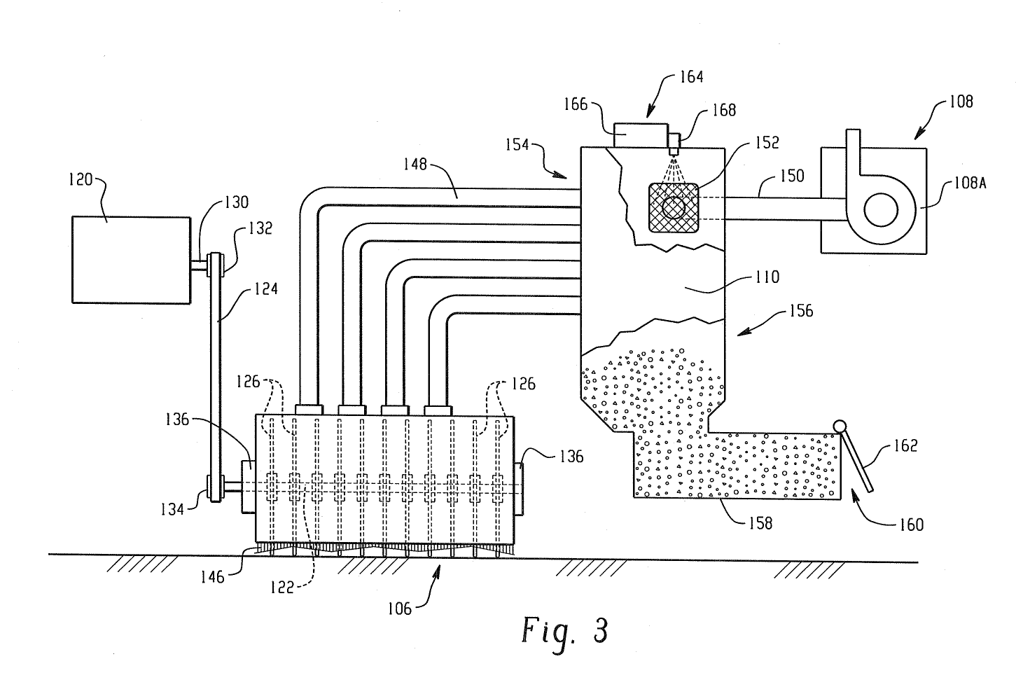

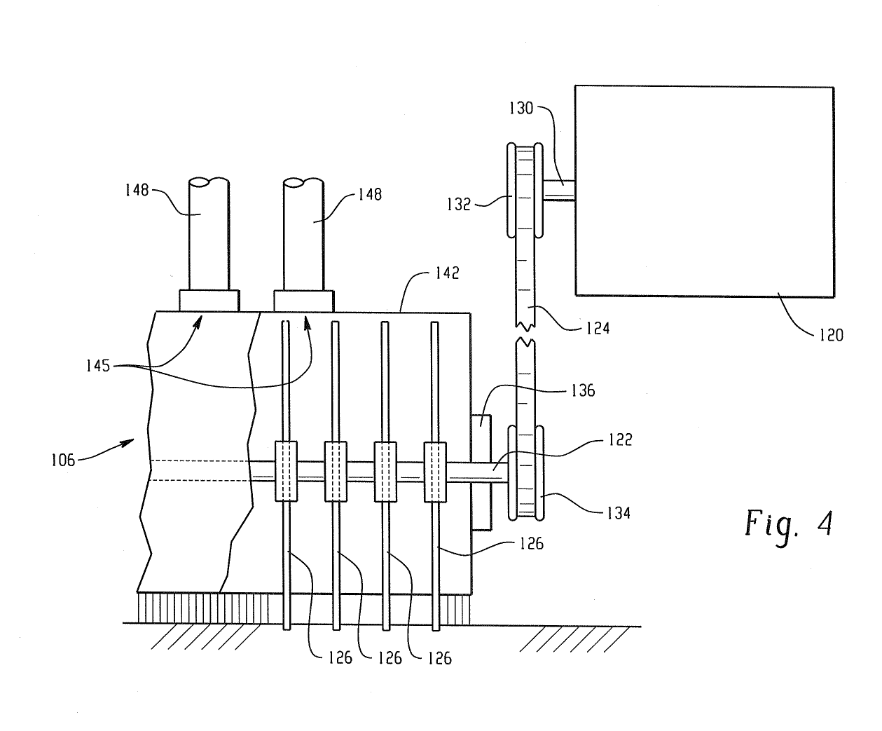

The arbor 122 is generally a shaft member which supports the plurality of diamond-tipped blades 126 and is rotatably supported by the profiling apparatus 100. As illustrated in FIGS. 3 and 4, the arbor 122 has a generally horizontal orientation and may be positioned to be substantially parallel with the surface to be profiled. As will be appreciated with reference to the below description of the operation of the cutting assembly 104, a substantial strain may be exerted on the arbor 122. As such, the arbor 122 may be formed of a high-strength material, such as a metal, steel, or a high-strength polymer.

The arbor 122 is rotatably supported at each of opposed end portions thereof by bearing assemblies 136, which may be provided on opposite outer surfaces of the housing 106, as will be described in further detail below. A driven end of the arbor 122 extends from the housing 106 and the respective bearing assembly 136, and has the belt receiving wheel 134 integrally formed thereon or secured thereto. The arbor belt receiving wheel 134, as illustrated, is disposed relatively outwardly from the adjacent bearing assembly 136. In this regard, the bearing assembly 136 disposed adjacent the driven end of the arbor 122 is configured to allow the arbor 122 to entirely pass therethrough so that the belt receiving wheel 134 may be so disposed. The end of the arbor 122 opposite the driven end is received, and may terminate, in the bearing assembly 136 opposite the driven end bearing assembly 136.

The bearing assemblies 136 may take the form of any assemblies capable of receiving end portions of the arbor 122 so as to support the arbor 122 while still allowing the arbor 122 to rotate. Such assemblies are believed to be generally well-known in the art, and as such will not be described in further detail herein. As noted above, the arbor 122 and the bearing assemblies 136 are configured such that the belt receiving wheel 134 of the arbor 122 engages the transmission member 124 to operationally link the power source drive shaft 130 to the arbor 122. As such, rotation of the power source drive shaft 130 drives rotation of the arbor 120 through the transmission member 124.

The plurality of diamond-tipped blades 126 (hereinafter, “blades 126”) are mounted to the arbor 122 so as to project orthogonally therefrom. Each of the blades 126 may be formed according to known circular-saw blade shapes so as to be disc-shaped and to define a generally circular peripheral shape with diamond tips provided along peripheral ends thereof. The blades 126 are integrally secured to or mounted on the arbor 122, which passes through a central portion of the blades 126, and are spaced from one another along the arbor 122. A radius of the blades 126 may be set to be greater than a distance between the arbor 122 and the surface to be profiled when the arbor 122 is in a lowered or profiling articulated position, which is described in further detail below. Additionally, the radius of the blades 126 may be set to be less than a distance between the arbor 122 and the surface to be profiled when the arbor 122 is in an elevated or non-operational position, which is also described in further detail below.

It is to be appreciated that, though the blades 126 are described herein as being “diamond-tipped blades”, the blades need not have diamond tips. Rather, the blades 126 may be formed wholly of a metal, steel, or any other material amenable for use as a saw blade, and may also have hardened tips through the provision of a material other than diamond or through an alternative forming technique. In this regard, diamond-tipped and other circular saw-type blades are considered to be generally well-known in the art, and will therefore not be described in further detail herein.

The subject profiling apparatus 100 is configured to remove and contain non-wetted concrete dust generated during the profiling operation. To allow the cutting assembly 104 to profile the concrete surface without wetting the blades 126, the profiling apparatus 100 is configured to drive the arbor 122 and blades 126 at a high rate of rotation which obviates the need to wet the blades 126 to prevent over-heating. In this regard, the recessed channel of the arbor belt receiving wheel 134 may have a circumference greater than that of the recessed channel of the power source drive shaft belt receiving wheel 132.

Through this configuration, a rotational speed of the arbor 122 may be greater than a rotational speed of the power source drive shaft 130. As noted above, the power source drive shaft 130 may have an output of 2100 rpm. The channel of the belt receiving wheel 134 provided on the arbor 122 may be configured to have a circumference which allows for rotation of the arbor 122 at approximately 5000 rpm when used with the power source 120 which creates a drive shaft output of 2100 rpm. By driving the arbor 122, as well as the blades 126 mounted thereon, at such a high rotational speed, the need to wet the blades 126 during profiling is reduced or eliminated. In this regard, the cutting assembly 104 is configured to profile the surface to be profiled through high-speed rotation of the blades 126. As used herein, “high speed rotation of the blades 126” references a blade rotation speed at which a wetting agent need not be used to cool the blades 126 during the profiling operation (e.g., high speed rotation may generally be approximately 5000 rpm for a circular saw blade).

It is further noted that the profiling of the surface to be profiled by the cutting assembly 104 need not necessarily be accomplished using a circular-saw type cutting assembly. Rather, any other manner of cutting assembly, such as those using alternative sawing or cutting techniques, may be substituted for the circular saw-type cutting assembly 104 described above. Moreover, it is also to be appreciated that the herein-described cuffing assembly 104 may be altered or modified in various manners while remaining within the scope of the instant disclosure. In this regard, the drive shaft output and the rotational speed of the arbor 122 and the blades 126 disclosed above are exemplary values which may be altered or changed. The cutting assembly 104 may take any form capable of profiling the surface to be profiled (which need not be asphalt or concrete) without introducing a wetting agent to wet the blades and/or the generated dust.

The movement and positioning of the profiling apparatus 100 may require the arbor 122 and blades 126 to be elevated and/or moved away from the surface to be profiled. To facilitate such movement, e.g., articulation of the arbor 122 and blades 126 relative to the base frame 102, the articulating mechanism 128 is provided. Generally, the articulating mechanism 128 is provided on the base frame 102 and connects the base frame 102 to the arbor 122, the bearing assemblies 136, and/or the housing 106, and is configured to allow the arbor 122 and blades 126 to be raised and lowered relative to the ground surface. Additionally, the articulating mechanism 128 may also be configured to move the arbor 122, the bearing assemblies 136, and/or the housing 106 in front-to-rear and side-to-side directions relative to the base frame 102.

As shown in FIG. 2, the articulating mechanism 128 may include a pair of articulating bases 138 provided on adjacent post members 112 and/or opposed cross members 112A. Each articulating base 138 has an articulating arm 140 secured thereto such that the articulating arm 140 is movable in at least an upward direction (toward the table 114) and a downward direction (toward the ground surface) by the articulating base 138. Each articulating arm 140 extends from the respective articulating base 138 toward the nearest end of the arbor 122. Each articulating arm 140, at an end opposed to the articulating base 138, may be secured to the adjacent bearing assembly 136 on the housing 106. As illustrated, a driven end articulating arm 140 is secured to the belt receiving wheel 134 of the arbor 122. It is noted that the articulating arm 140 and the belt receiving wheel 134 are secured to one another such that the belt receiving wheel 134 may rotate with the arbor 122 while the articulating arm 140 remains rotationally stationary.

The articulating bases 138 are configured to raise and lower the articulating arms 140 according to a user command entered at the user control section. Each articulating arm 140, through its engagement with the bearing assembly 136 and/or the belt receiving wheel 134, both of which are directly or indirectly attached to both the housing 106 and the arbor 122, can thereby raise and lower the arbor 122, the blades 126, and the housing 106. The articulating arms 140 may alternatively or additionally be attached to any one or more of the arbor 122 and/or to the housing 106 itself.

In addition to facilitating upward and downward motion, the articulating mechanism 128 may also be configured to allow for lateral and horizontal articulation of the arbor 122, the blades 126, and the housing 106 relative to the base frame 102. To facilitate such motion, the articulating bases 138 may be provided along a length of cross members 112A disposed adjacent to outer sides of the housing 106, and may be configured to move the articulating arms 140 in a front-to-rear direction and/or a side-to-side direction relative to the base frame 102. In this regard, the articulating mechanism 128 may be configured to provide at least six directions of motion.

It is noted that the articulating mechanism 128 is generally or schematically illustrated in FIG. 2. In this regard, articulating mechanisms of this variety are believed to be generally well-known in the art, and as such is not illustrated or described in detail herein. It is, nevertheless, to be appreciated that the disclosed articulating mechanism 128 may be modified while remaining within the scope of the instant disclosure. For example, the articulating mechanism 128 may employ fewer or greater than two articulating bases 138 and arms 140, and may be secured to alternative portions of the profiling apparatus 100. Additionally, the articulating mechanism may take an entirely different form, such as a track-based assembly along which the housing 106, arbor 122, and bearing assemblies 136 are movable. It is also noted that the profiling apparatus 100 may be provided without an articulating mechanism 128.

The housing 106 is provided to enclose a profiling area in which a portion of the arbor 122, the blades 126, and the surface to be profiled are contained or substantially enclosed. The housing 106, as illustrated in FIGS. 1-4, is a generally rectangular box-shaped member disposed over the portion of the arbor 122 on which the blades 126 are mounted. The housing 106 includes an upper surface 142 and four side surfaces 144 which define a rectangular box with an open lower surface, as well as an apron 146 which extends from lower edges of the four side surfaces 144. The housing 106 communicates with the surface to be profiled so as to fully cover and enclose the surface, as well as the blades 126. Each of two opposed side surfaces 144 of the housing 106 have one bearing assembly 136 provided thereon such that the arbor 122 extends between the bearing assemblies 136 within the housing 106. The arbor 122 may be positioned within the housing 106 such that lower portions of the blades 126 protrude from the open lower surface of the housing 106.

The housing 106, through mutual engagement with bearing assemblies 136, is supported by the articulating arms 140 so as to be integrally movable towards and away from the surface to be profiled. When in the lowered or profiling articulated position, the housing 106 is configured such that the apron 146 is made to abut the surface to be profiled. Accordingly, the blades 126 of the profiling apparatus 100 may profile the surface to be profiled within the profiling area enclosed by the housing 106 such that any dust generated during the profiling operation is substantially contained within the housing 106. When in the elevated or non-operational position, the apron 146 and the blades 126 are spaced from the ground surface to facilitate movement of the profiling apparatus 100 or the articulation of the cutting assembly 104.

The apron 146 may be formed of a plurality of bristles which extend in a downward direction from lower portions of the four side surfaces 144 of the housing 106. When in the lowered or profiling articulated position, the apron 146 is configured to contact and press against the surface to be profiled and cooperates with the side surfaces 144 and upper surface 142 of the housing 106 to create an enclosed profiling area for containing dust generated during profiling. Furthermore, by forming the apron 146 from a plurality of bristles, air flow is still allowed to enter the enclosed profiling area within the housing 106, which may facilitate or support the generation of a suction force within the housing 106. It is to be appreciated that the apron 146 need not be formed of a plurality of bristles, and can be alternatively configured to include any member capable of flexibly defining a lower portion of the housing 106 so as to prevent dust generated during profiling from escaping the profiling area enclosed by the housing 106.

To facilitate removal of the dust contained within the housing 106, the upper surface 142 of the housing 106 has a plurality of outlet openings 145, illustrated as four outlet openings 145, defined therethrough. The outlet openings 145 allow the enclosed profiling area of the housing 106 to communicate with the suction assembly 108 and the container 110. In this regard, a plurality of flexible conduits 148 are each attached to the housing 106 such that each of the housing outlet openings 145 is in communication with one of the conduits 148. Each of the conduits 148 is connected to a first surface of the container 110 at container inlet openings so as to communicate with an interior of the container 110. As such, the profiling area enclosed by the housing 106 is in communication with the interior of the container 110 through the conduits 148.

The conduits 148 may be formed of a flexible and/or translucent material, such as a wire-reinforced polymeric tubing. By forming the conduits 148 of a flexible material, replacement thereof at a job site is simplified. By forming the conduits 148 from a translucent material, preventative maintenance of the profiling apparatus 100 may be improved by simplifying the identification of blockages within the conduits 148 (e.g., visual inspection of the interior of the conduits 148 is facilitated).

The suction assembly 108 is illustrated as being provided on a second surface of the container 110, which may be different from the first surface of the container 110 to which the conduits 148 are connected. In this regard, the suction assembly 108 may be supported by the container 110, the base frame 102 (e.g., the table 114), or both, and interact with any portion of the container 110 (e.g., other than the “second surface”). The suction assembly 108 is provided to be in communication with the interior of the container 110 through a container suction opening defined in the container 110, and is configured to generate a suction force. The suction force generated by the suction assembly 108 is communicated to the conduits 148 through the interior of the container 110, and is exerted within the profiling area enclosed by the housing 106. As such, during the profiling operation, the suction assembly 108 causes a suction force to be applied within the profiling area enclosed by the housing 106 so as to draw the dust from the housing 106, through the conduits 148, and into the container 110.

With more particular respect to the suction assembly 108, it is noted that any manner of suction assembly 108 may be amenable for use with the herein disclosed profiling apparatus 100. Suction assemblies are believed to be generally well-known in the art, and as such will not be described in detail herein. It is noted that the suction assembly 108 may be configured to generate a suction force of approximately 1200 CFM, which when applied with the herein described profiling apparatus 100 having conduits 148 with 60 square-inch openings, has been observed to effectively remove most or substantially all of the dust generated during the profiling operation from the housing 106. An exemplary suction assembly 108 may be the DUSTAR®, manufactured by the Waltz-Hoist Co.

As shown in FIG. 3, the suction assembly 108 includes a suction device 108A which communicates with the interior of the container 110 via a suction conduit 150 which extends from the suction device 108A and into the interior of the container 110, e.g., the suction conduit 150 communicates the suction device 108A with the container suction opening. A suction force generated by the suction device 108A is thereby applied within the conduits 148 and the housing 106 in the direction of the container 110. To prevent dust received within the container 110 from entering the suction assembly 108, e.g., the suction device 108A and the suction conduit 150, an open end of the suction conduit 150 within the container 110 has a flexible membrane filter 152 provided thereon.

The flexible membrane filter 152 may be an internally supported filter 152 disposed within the container 110 and covering an opening of the suction conduit 150 and/or the suction opening defined in the container 110. The filter 152 is adapted to separate dust from a dust-air mixture entering the container 110 through the suction force generated by the suction device 108A, such that the separated dust falls into the container lower portion 156. It is further noted that at least a portion of the dust in the dust-air mixture which contacts the filter 152 will be caked on the filter 152. The separated air flows through the filter 152 and suction conduit 150 to the suction device 108A, where it is ultimately expelled as exhaust. The filter 152 may be formed of any material suitable for use as a filter in a profiling suction device, and as such is configured to prevent dust generated during the profiling operation from reaching and potentially damaging the suction assembly 108, e.g., the suction device 108A.

With reference to the container 110, as well as serving as a fluid communication intermediary between the suction assembly 108 and the conduits 148 and housing 106, the container 110 also serves as a containment vessel for dust removed from the housing 106. In this regard, the container 110 is a generally hollow vessel having an upper portion 154, wherein the suction conduit 150, the filter 152, and inlet openings associated with the conduits 148 are provided, and a lower portion 156 where the dust removed from the housing 106 and brought into the interior of the container 110 is stored (e.g., a container chamber).

The container 110 may be principally supported by the table 114 of the base frame 102. As shown in FIG. 1, the container 110 is attached to the table 114 such that a portion of the container 110 is disposed above the table 114 and a portion of the container 110 is disposed below the table 114. It is noted that the portions of the container 110 disposed above and below the table 114 need not necessarily correspond to the upper and lower portions 154, 156 of the container 110, which are delineated within the instant disclosure based on function (dust received in the upper portion 154 and contained in the lower portion 156). It is further noted that the container 110 may be alternatively situated or disposed relative to the table 114 and/or any alternative base frame configuration.

The container lower portion 156 includes an evacuation leg 158 at a lowermost portion thereof, and the evacuation leg 158 includes an evacuation opening 160 selectively openable and closable by an evacuation door 162. The evacuation leg 158 may be configured to facilitate emptying of collected dust from the container 110, and is therefore disclosed herein as being provided at a lowermost portion thereof. Moreover, the evacuation leg 158 may be disposed such that the evacuation opening 160 is disposed in an easily reachable position on the profiling apparatus 100 so as to facilitate emptying of the container 110. As shown in FIG. 1, the exemplary container evacuation leg 158 is configured and situated such that the evacuation opening 158 is at a lower, rearward position. It is to be appreciated that the evacuation leg 158 may be alternatively configured or situated.

The evacuation door 162, as shown in FIGS. 2-4, is hingedly secured to a portion of the evacuation leg 158 adjacent to the evacuation opening 160. It is to be appreciated that the evacuation door 160 may be secured to the evacuation leg 158 in any other manner. The evacuation door 162 may also include a locking or stabilizing mechanism to hold the evacuation door 162 in either or both of a closed position and an opened position.

As noted with respect to the container upper portion 154, a plurality of inlet openings associated with the plurality of conduits 148 are formed in a sidewall of the container 110 such that dust suctioned from the housing 106 and through the conduits 148 may be deposited within the container 110. Additionally, the container upper portion 154 is provided with a filter cleaning assembly 164 which may be disposed on an upper surface of the container 110 and is in communication with the interior of the container 110. The filter cleaning assembly 164 includes a compressed air source 166, in which compressed air is stored, and an air port 168 which communicates the compressed air source 166 with the interior of the container 110 such that the air port 168 directs compressed air from the compressed air source 166 toward the filter 152.

The air port 168 is configured to periodically direct a jet of compressed air toward the filter 152. More particularly, the air port 168 may be configured to deliver precisely calibrated air flow to the filter 152 at predetermined time intervals, such as every minute. The jet of compressed air, or the air flow, may be calibrated so as to exert a sufficient force on the filter 152 to loosen and remove any dust caked thereon. By removing caked-on dust from the filter 152, the operation and efficiency of the suction assembly 108 may be improved.

In operation, the profiling apparatus 100 may be moved using the wheels 116 and the drive system 118 to a position wherein the arbor 122, the blades 126, and the housing 106 are disposed over a ground surface to be profiled. The profiling apparatus 100 may be moved while the arbor 122, the blades 126, and the housing 106 are in the elevated or non-operational articulated position. Once positioned, the brake assembly may be activated to prevent rotation of the wheels 116, and the arbor 122, blades 126, and the housing 106 may be articulated in a front-to-rear and/or side-to-side direction, as well as placed in the lowered or profiling articulated position using the articulating mechanism 128. The user control section may be used to allow the user to control the movement of the profiling apparatus 100 and the articulation of the arbor 122, blades 126, and the housing 106.

The cutting assembly 104 may then be activated to begin the profiling operation. The cutting assembly 104 is activated by operating the power source 120 to drive rotation of the power source drive shaft 130. The rotation of the power source drive shaft 130 is transmitted to the arbor 122 via the transmission member 124. As the arbor 122 rotates, the blades 126 integrally rotate therewith so as to cut/profile the surface to be profiled. It is noted that the cutting assembly 104 may be activated prior to the articulating mechanism 128 lowering the arbor 122, blades 126, and the housing 106 to the lowered or profiling articulated position. Additionally, the articulating mechanism 128 may cause the arbor 122, the blades 126, and the housing 106 to articulate in a front-to-rear direction relative to the base frame 102 so as to cut, profile, or groove the surface to be profiled along a line or path.

Simultaneously, or near-simultaneously, with the activation of the cutting assembly 104, the suction assembly 108 may also be activated. The suction device 108A, once activated, generates a suction force which is communicated from the suction conduit 150 in the interior of the container 110 to the conduits 148 and the profiling area enclosed by the housing 106. As such, any dust generated during the profiling operation is removed from the housing 106, through the conduits 148, and brought into the container 110 for containment in the container lower portion 156. The container 110 may then be emptied through the evacuation opening 160 provided in the evacuation leg 158 of the container 110.

The herein disclosed suction assembly 108 is operable to remove non-wetted dust generated during the profiling operation. The profiling operation performed by the herein described profiling apparatus 100 is performed without a wetting agent used to wet and/or cool the blades 126. While conventional profiling machines require a wetting agent to prevent the blades 126 from overheating, the profiling apparatus 100 described herein obviates the need for use of a wetting agent by increasing the rotational speed of the blades 126 during the profiling operation. The resultant dust generated from the profiling operation is therefore a collection of dry particulates, rather than a slurry, which may be more easily suctioned, contained, and/or handled. Furthermore, the increased blade speed creates smaller dust particles as compared with a slower blade speed. The relatively smaller particulates are more easily removed or suctioned from the profiling area enclosed by the housing 106 than the conventional slurry or larger dust particulates. In this regard, the suction device 108A may generate 1200 CFM of suction force which is applied to the profiling area of the housing 106 via 60 square-inch sized conduits to effectively remove most or substantially all of the generated dust.

With further respect to the user control section, while not illustrated, it is noted that an exemplary control section may include a steering wheel to give the operator control over the direction in which the profiling apparatus 100 is moved. The user control section may also provide various gauges and controls to provide the operator with information and means for adjusting various components of the profiling apparatus 100, such as the performance of the power source 120, the suction assembly 108, the speed of rotation of the arbor 122 and blades 126, the depth of the profiling cut (e.g., the upward and downward articulation of the arbor 122, the blades 126, and the housing 106), and the speed and direction at which the profiling apparatus 100 is articulating with respect to the frame.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A dust removal system for use with a concrete or asphalt profiling apparatus, the dust removal system comprising:
a housing configured to cooperate with the surface to be profiled so as to create an enclosure that contains at least one saw blade of a cutting assembly which is configured to profile a surface to be profiled through high-speed rotation of at least one saw blade, the housing having an outlet opening; and
a suction assembly in fluid communication with the housing outlet opening and configured to generate a suction within the housing.

2. The dust removal system according to claim 1, wherein ground adjacent surfaces of the housing define an access opening allowing at least a portion of the at least one saw blade of the cutting assembly access to the surface to be profiled, and the housing further comprises an apron member extending from the ground adjacent surfaces of the housing toward the surface to be profiled, the apron member configured to substantially prevent dust from escaping the housing while allowing air flow to enter the housing.

3. The dust removal system according to claim 1, wherein the suction assembly further comprises:
a suction device configured to generate suction; and
a conduit fluidly connecting the suction device to the housing outlet opening.

4. The dust removal system according to claim 3, wherein the housing has a plurality of outlet openings and the suction assembly includes a plurality of conduits, wherein each of the plurality of conduits fluidly connects the suction device with one of the plurality of housing outlet openings.

5. The dust removal system according to claim 2, wherein the suction assembly further comprises:
a suction device configured to generate suction; and
a conduit fluidly connecting the suction device to the housing outlet opening.

6. The dust removal system according to claim 3, further comprising a container, the container including:
a container inlet opening fluidly connected to the housing outlet opening through the conduit;
a container suction opening fluidly connected to the suction device; and
a container chamber for collecting the dust removed from the housing.

7. The dust removal system according to claim 6, further comprising an internally supported filter membrane disposed within the container and covering the container suction opening, the filter membrane being adapted to separate dust from air such that at least a portion of the dust falls into the container chamber and at least a portion of the dust cakes on the filter membrane.

8. The dust removal system according to claim 7, wherein the container further comprises
a compressed air source; and
an air port communicating the compressed air source with an interior of the container, the compressed air port adapted to selectively expel compressed air supplied by the compressed air source toward the filter membrane to dislodge dust caked thereon.

9. The dust removal system according to claim 6, wherein the container chamber includes an evacuation opening selectively covered by a door movable between an open position and a closed position, the door allowing for removal of dust collected in the container chamber through the dust outlet opening when the door is in the open position.

10. The dust removal system according to claim 3, wherein a suction-to-opening ratio between the suction device and an opening defined by the conduit is 20 cubic feet per minute per square inch.

11. An apparatus for profiling a concrete or asphalt surface, comprising:
a cutting assembly adapted to profile the surface through high-speed rotation of at least one blade;
a housing configured to cooperate with the surface so as to create an enclosure that contains the at least one blade of the cutting assembly, the housing having an outlet opening; and
a suction assembly in fluid communication with the housing outlet opening and configured to generate a suction within the housing.

12. The apparatus according to claim 11, wherein the cutting assembly comprises:
a arbor;
a power supply configured to rotate the arbor; and
the at least one blade is a plurality of diamond-tipped blades mounted to the arbor.

13. The apparatus according to claim 12, wherein the power supply and arbor are connected such that the power supply rotates the arbor at a maximum rotational speed of at least 4000 rpm.

14. The apparatus according to claim 12, wherein ground adjacent surfaces of the housing define an access opening allowing at least a portion of the plurality of diamond-tipped blades access to the surface, and the housing further comprises an apron member extending from the ground adjacent surfaces of the housing toward the surface, the apron member being configured to substantially prevent dust from escaping the housing while allowing air flow to enter the housing.

15. The apparatus according to claim 11, wherein the suction assembly further comprises:
a suction device configured to generate suction; and
a conduit fluidly connecting the suction device to the housing outlet opening.

16. The apparatus according to claim 15, further comprising a container, the container including:
a container inlet opening fluidly connected to the housing outlet opening through the conduit;
a container suction opening fluidly connected to the suction device; and
a container chamber for collecting the dust removed from the housing.

17. The apparatus according to claim 16, further comprising an internally supported filter membrane disposed within the container and covering the container suction opening, the filter membrane being adapted to separate dust from air such that at least a portion of the dust falls into the container chamber and at least a portion of the dust cakes on the filter membrane.

18. The apparatus according to claim 17, wherein the container further comprises
a compressed air source; and
a compressed air port communicating the compressed air source with an interior of the container, the compressed air port adapted to selectively expel compressed air supplied by the compressed air source toward the filter membrane to dislodge dust caked thereon.

19. A method of profiling a concrete or asphalt surface, the method comprising:
providing a profiling apparatus comprising:
a cutting assembly adapted to profile the surface and including an arbor, a power supply configured to generate high-speed rotation of the arbor, and a plurality of diamond-tipped blades mounted to the arbor;
a housing configured to cooperate with the surface so as to create an enclosure that contains the cutting assembly, the housing having an outlet opening; and
a suction assembly in fluid communication with the housing outlet opening and configured to generate a suction within the housing;
operating the power supply such that it supplies power that rotates the arbor and the plurality of diamond-tipped blades mounted thereon;
contacting the diamond-tipped blades mounted on the rotating arbor with the surface such that a profile is formed in the surface and a mixture of non-wetted dust and air is formed;
suctioning the mixture of non-wetted dust and air from the housing.

20. The method according to claim 19, wherein providing a profiling apparatus further includes providing:
a container for collecting dust, the container including a container inlet connected to the housing outlet via a conduit, a container outlet in fluid communication with the suction assembly, and a container chamber;
an internally supported filter membrane extending into the container and covering the container outlet;
a compressed air source; and
a compressed air port adapted to selectively expel compressed air supplied by the compressed air toward the filter membrane, and
the method further comprises:
separating the non-wetted dust from the air using the internally supported filter membrane such that at least a portion of the dust falls into the container chamber, at least a portion of the dust cakes on the filter membrane, and air separated from the dust passes through the filter membrane and exits the container through the container outlet; and
selectively expelling compressed air supplied by the compressed air source toward the filter membrane to dislodge dust caked thereon.
